(19) United States
(12) Patent Application Publication
(10) Pub. No.: US 2007/0116216 A1
(43) Pub. Date: May 24, 2007

(54) Dynamic Directory Auction Service

(75) Inventors: Steve Carmichael, Atlanta, GA (US); Charles Stubbs, Pasadena, CA (US)

Correspondence Address: THOMAS, KAYDEN, HORSTEMEYER & RISLEY, LLP/;BELLSOUTH I.P. CORP, 100 GALLERIA PARKWAY, SUITE 1750, ATLANTA, GA, 30339, US

(73) Assignee: BELLSOUTH INTELLECTUAL PROPERTY CORPORATION, Wilmington, DE (US)

(21) Appl. No.: 11/463,138

(22) Filed: Aug. 8, 2006

Related U.S. Application Data
(60) Provisional application No. 60/734,360, filed on Nov. 7, 2005.

(51) Int. Cl. H04M 15/00

(52) U.S. Cl. 379/114.01

(57) ABSTRACT

One embodiment of a method for selling services includes the following steps: enabling a seller to create a listing of a service that is available to be bid upon in an online marketplace, the service comprising work that is offered to be performed by the seller, wherein the listing is network-accessible by a client machine of a user; enabling the seller to specify available dates for performing work specified in the service listing; and enabling the user to view the available dates for the service that is up for auction before having to place a bid for the service that is currently up for auction. Other methods and devices are also provided.

### CROSS-REFERENCE TO RELATED APPLICATION

This application claims priority to copending U.S. provisional application entitled, “SERVICES E-COMMERCE MARKETPLACE,” having Ser. No. 60/734,360, filed Nov. 7, 2005, which is entirely incorporated herein by reference.

### TECHNICAL FIELD

The present disclosure is generally related to network computer systems and, more particularly, is related to an online marketplace.

### BACKGROUND

Often, service providers, such as plumbers, dentists, restaurants, etc., advertise their services using telephone directories, print advertisements, radio and television advertisements, etc. With the emergence of the Internet, many service providers are also advertising online via online telephone directories, Web site banners on third party sites, company Web sites, etc. However, a consumer who is desiring a service to be performed, even when confronted with an online advertisement for that service, has to take several steps on his or her own before an agreement is reached with a service provider to provide that service. For example, a telephone call is usually made to the service provider so that negotiations may take place to schedule an acceptable price and time for the service to be performed.

With respect to an advertisement provider, such as an online telephone directory provider, the provider is generally compensated for the amount of traffic that is generated to a service provider's listing information or Web site. One popular way this is done is via a pay per click model, where the advertisement provider may receive a certain amount of money (e.g., 4 cents) for every click initiated by a user that directs the user to the service provider's listing information. Another popular way is to charge a set fee for an advertisement to be shown on an online directory, or even a paper telephone directory. However, from the standpoint of a consumer, the buying decision involved in determining which business to select from an assortment of listings and/or advertisements found in a telephone directory or “yellow pages” is a complex process.

Thus, a heretofore unaddressed need exists in the industry to address the aforementioned deficiencies and inadequacies.

### SUMMARY

One embodiment of a method for selling services includes the following steps: enabling a seller to create a listing of a service that is available to be bid upon in an online marketplace, the service comprising work that is offered to be performed by the seller, wherein the listing is network-accessible by a client machine of a user; enabling the seller to specify available dates for performing work specified in the service listing; and enabling the user to view the available dates for the service that is up for auction before having to place a bid for the service that is currently up for auction.

In another embodiment, a method for selling services may be broadly summarized the following steps: providing a listing of services that are available to be bid upon in an online marketplace, the services comprising work that is offered to be performed by a plurality of businesses; enabling a user to view an individual listing of a service that is being offered to be performed by a business in an online auction; and crediting a provider of the online marketplace based upon a number of visits to the individual listing, wherein the business pays a pre-arranged fee to the provider based upon the number of visits.

Embodiments also include a computer readable medium having a computer program for performing the above methods. Other systems, methods, features, and advantages of the present disclosure will be or become apparent to one with skill in the art upon examination of the following drawings and detailed description. It is intended that all such additional systems, methods, features, and advantages be included within this description and be within the scope of the present disclosure.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram of one embodiment of a dynamic directory auction system.

FIG. 2 is a block diagram of an embodiment of a client-server environment in which the system of FIG. 1 may be facilitated.

FIG. 3 is a block diagram of a computer system representing an exemplary server which may be utilized in the system of FIG. 1.

FIG. 4 is a block diagram illustrating one embodiment of a service marketplace system from FIG. 1.

FIGS. 5-11 are diagrams describing embodiments of an interface to a service marketplace system of FIG. 4.

FIG. 12 is a flow chart diagram of one embodiment of a process for creating service listings within the system of FIG. 4.

FIGS. 13-16 are flow chart diagrams of embodiments of flexible bidding approaches for the system of FIG. 4.

FIGS. 17-20 are diagrams describing embodiments of an interface to a service marketplace system of FIG. 4.

FIGS. 21-23 are flow chart diagrams of embodiments of processes for facilitating the system of FIG. 1.

### DETAILED DESCRIPTION

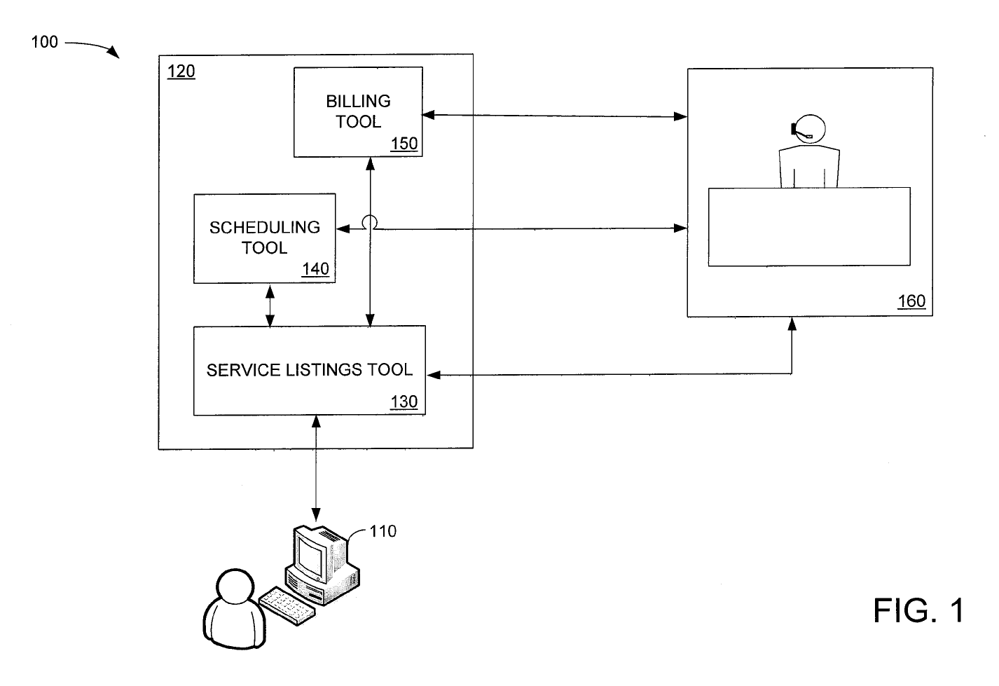

Referring to FIG. 1, one embodiment of a dynamic directory auction system 100 is shown. According to an exemplary embodiment, the dynamic directory auction system facilitates creation of a marketplace for the commodization of services. While the description that follows is directed to a marketplace for services for simplicity of explanation, it should be appreciated that exemplary embodiments may also be applicable to a marketplace for goods. Generally, a service may be regarded as work performed by a person or business for another person or customer at an agreed upon fee (hourly rate, flat fee, etc.). Often, the buying decision in selecting a business for performing for such services is complex. For example, a business may be selected upon a referral from friends. However, if a referral is not able to be obtained, then a decision is made upon little or no solid information. Therefore, the dynamic directory auction system 100 of the present disclosure helps simplify the buying process to the benefit of consumers, service providers, such as businesses, and a provider or publisher of information about a service listing offered by a service provider.

Within one embodiment of a dynamic directory auction system 100, a user at a client device 110 accesses a service marketplace system 120, as shown in FIG. 1. Via the service marketplace system 120, the user may access a service listing tool or module 130 that maintains a listing of currently active auctions for services offered by service providers, such as businesses involving restaurants, home repair, house maintenance, medical services, hair styling, etc. From a user standpoint, the service listing tool 130 may also be used as an interface to a scheduling tool or module 140 and billing tool or module 150. A service provider 160 may access the service listing tool 130 to create or modify service listings directed to currently active auctions. Further, the service provider may be provided the ability to access the scheduling tool 140 and billing tool 150 directly without having to utilize a service listing tool 130 as an interface to the scheduling and billing tools. For example, both the user of the client device 110 and the service provider 160 may register with the service marketplace system 120 and establish username and passwords for the system 120. The service provider 160, however, may be provided different privileges than the user of the client device 110. Accordingly, the service marketplace system 120 provides the service provider 160 direct access to the billing and scheduling tools 150, 140 upon recognition of the username and password of the service provider 160.

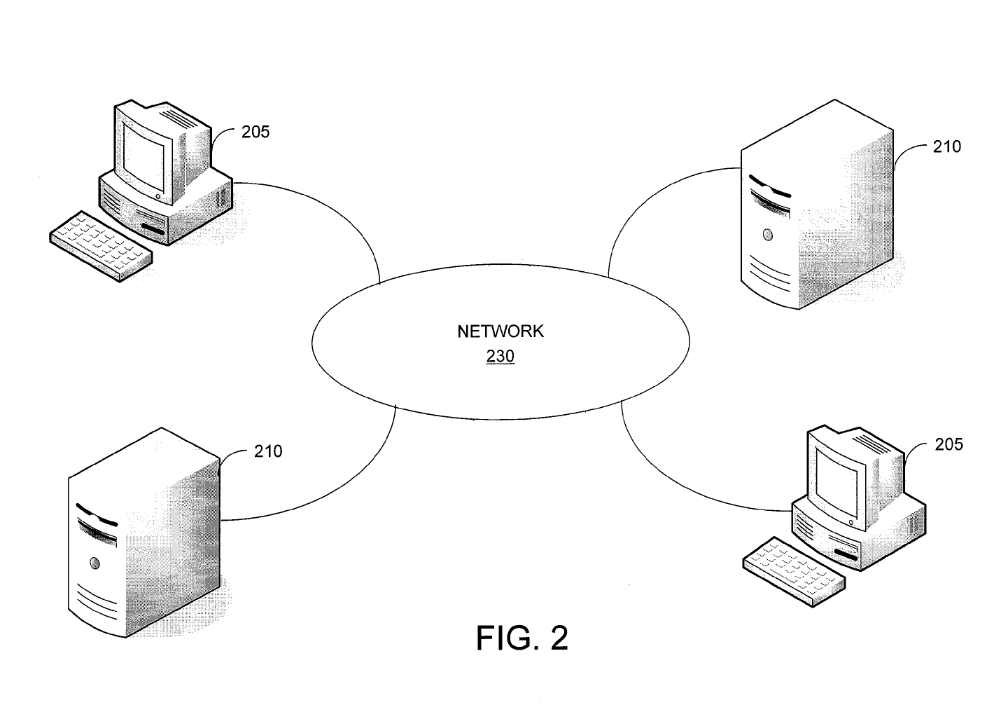

Next, FIG. 2 shows one embodiment of a client-server environment, such as the World Wide Web (the Web), in which the dynamic directory auction system 100 may be facilitated. The architecture of the Web follows a client-server model. The terms “client” and “server” are used to refer to a computer's general role as a requester of data (the client) or provider of data (the server). Web clients 205 and Web servers 210 communicate using a protocol such as HyperText Transfer Protocol (HTTP). In the Web environment, Web browsers reside on clients and render Web documents (pages) served by the Web servers. The client-server model is used to communicate information between clients 205 and servers 210. Web servers 210 are coupled to the network 230 (e.g., Internet) and respond to document requests and/or other queries from Web clients 205. When a user selects a document by submitting its Uniform Resource Locator (URL), a Web browser, such as Mozilla Firefox®, Netscape Navigator, or Internet Explorer®, opens a connection to a server 210 and initiates a request (e.g., an HTTP get) for the document. The server 210 delivers the requested document, typically in the form of a text document coded in a standard markup language such as HyperText Markup Language (HTML).

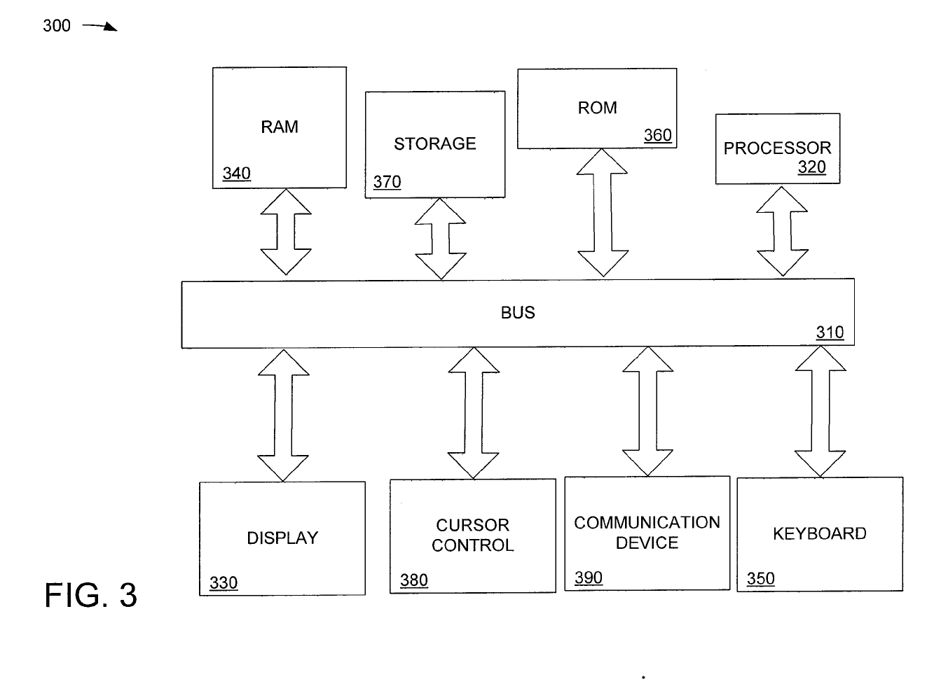

Accordingly, FIG. 3 is a computer system 300 representing an exemplary server which may be utilized in the system of FIG. 1. Computer system 300 comprises a bus or other communication means 310 for communicating information, and a processing means such as processor 320 coupled with bus 310 for processing information. Computer system 300 further comprises a random access memory (RAM) or other dynamic storage device 340 (referred to as main memory), coupled to bus 310 for storing information and instructions to be executed by processor 320. Main memory 340 also may be used for storing temporary variables or other intermediate information during execution of instructions by processor 320. Computer system 300 also comprises a read only memory (ROM) and/or other static storage device 360 coupled to bus 310 for storing static information and instructions for processor 320.

A data storage device 370 such as a magnetic disk or optical disc and its corresponding drive may also be coupled to computer system 300 for storing information and instructions. Computer system 300 can also be coupled via bus 310 to a display device 330, such as a cathode ray tube (CRT) or Liquid Crystal Display (LCD), for displaying information to a computer user. Typically, an alphanumeric input device 350 (e.g., a keyboard), including alphanumeric and other keys, may be coupled to bus 310 for communicating information and/or command selections to processor 320. Another type of user input device is cursor control 380, such as a mouse, a trackball, or cursor direction keys for communicating direction information and command selections to processor 320 and for controlling cursor movement on display 350.

A communication device 390 is also coupled to bus 310 for accessing remote servers via a network, such as the Internet, for example. The communication device 390 may include a modem, a network interface card, or other commercially available network interface devices, such as those used for coupling to an Ethernet, token ring, or other type of network. In any event, in this manner, the computer system 300 may be coupled to a number of clients and/or other servers via a conventional network infrastructure, such as a company's Intranet and/or the Internet, for example.

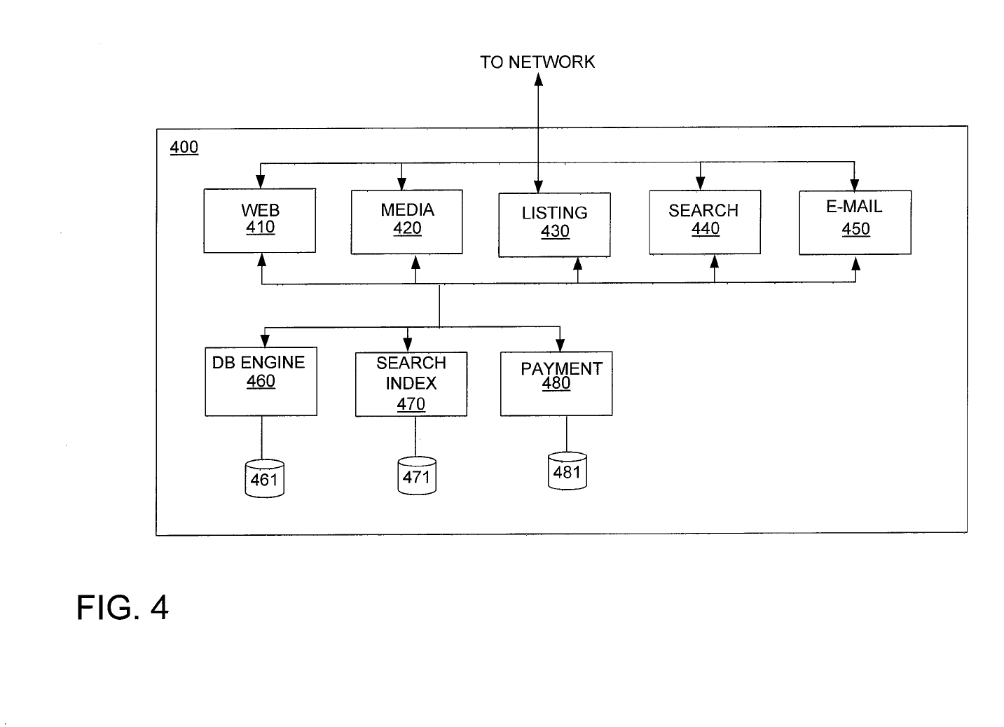

FIG. 4 is a block diagram illustrating one embodiment of an online e-commerce system in the form of a service marketplace system 400. The service marketplace system 400 includes one or more of a number of types of front-end servers, namely Web servers 410 that deliver Web pages (e.g., markup language documents), media servers 420 that dynamically deliver images and other media to be displayed within Web pages, listing servers 430, and search servers 440 that handle search requests to the system 400. E-mail servers 450 provide automated e-mail communications to users of the system 400.

The back-end servers include a database engine server 460, a search index server 470, and a payment database server 480, each of which maintains and facilitates access to a respective database.

Databases 461, 471, 481 associated with the database engine server 460, search index server 470, and payment database server 480, respectively, may include information which may be described as seller information. Such information may include a service provider's Internet address, personnel information, transaction information, and user codes and settings (e.g., username, passwords, profiles, preferences, etc.). In addition, the databases 461, 471, 481 may include buyer's information, such as buyer preferences, personal information, user codes and settings, payment information, etc.

Generally, system servers and databases may maintain a collection of service information, maintain an identification of different services to be auctioned, be capable of promoting the services and the designated time of the auction prior to the auction to increase awareness of the service, conduct the auction itself, arrange for payment of the service by the buyer, and arrange for scheduling of the service by the seller.

The network-based service marketplace system 400 may be accessed by a client program, such as a Web browser that executes on a client machine 1110, 205 and accesses the system 400 via a network 230 such as, for example, the Internet. Other examples of networks that a client may utilize to access the system 400 include a wide area network (WAN), a local area network (LAN), a wireless network (e.g., a cellular network), or the Plain Old Telephone Service (POTS) network. The client machine 110, 205 may be a personal computer, mobile telephone, personal digital assistant (PDA). In fact, the client machine 110, 205 may be any device that can communicate with the system 400 via the network 230, and is capable of executing an appropriate client program.

Buyers may search databases 461, 471, 481 for particular services that they are interested in bidding on. This is accomplished by software that is resident on the Web servers 410, which enable browsing and searching by buyers of service listings stored on the database. This software may also enable the buyer to store their browse and search criteria in order to facilitate repetitive queries for services on which they are interested in bidding. Search functions may include partial key searches, as well as the ability to select items based on Boolean search criteria, such as price or type of service. As bids are received from buyers for a particular service, the highest bid is updated. In addition, a clock may be shown to inform buyers of the time remaining on an auction for a particular service.

For security reasons, the service marketplace system 400 may be utilized in conjunction with a firewall or other security measure (not shown) to ensure confidentiality of sensitive information such as financial information.

The service marketplace system 400 is designed to make services transparent (with ample information provided about the service and the service provider) so that a potential buyer is secure in making a decision to obligate himself or herself to buy a service from a service provider based solely upon the information provided by the service marketplace system 400. Information provided on the system 400 may include customer ratings regarding the service provider, pricing information, special offers, upfront scheduling ability, etc. A consumer or buyer can research pricing information, consumer's reviews or ratings, take advantage of a bid environment and competition amongst service providers without having to call multiple different service providers, for example, and perform the necessary legwork himself or herself. The service marketplace system 400 generates its own competition amongst service providers to the benefit of consumers and generates competition amongst consumers to the benefit of service providers.

Via the service marketplace system 400, businesses have the opportunity to participate in bidding processes for future work and can choose what type of bidding processes they want to participate in. Via a Web browser client, they also gain access to useful tools provided and maintained by the marketplace system, including scheduling and organizational tools 140, online billing tools 150, etc.

Further, a provider of the service marketplace system may receive a fee from the service provider for publicizing their services and offering their services for sale via the marketplace system 400. A variety of fee arrangements may be agreed upon.

As shown in the figures provided, a service provider that seeks to engage a consumer in a service transaction may register or subscribe with a provider of the service marketplace system 400. This service provider, via a Web browser, connects to a Web server 410 of the service marketplace system 400, where the service provider provides information about itself. The seller's or service provider's profile information, user information, and information related to the offered service are stored and maintained in one or more databases 461, 471, 481. Once a seller is registered, it may then offer services for sale. To do so, the seller provides certain information about the service such as a description of the service.

Like with the sellers, via a Web browser, interested buyers or users may register with the service marketplace system 400. The registration information provided by a buyer may be stored in databases 461, 471, 481 of the service marketplace system. Buyers are queried to provide demographic information, including name, address, telephone number, and e-mail addresses. In addition, buyers are prompted to establish a user code and settings, as previously mentioned. Via demographic information, browsing, searching, and bidding may be restricted to services that offered in the same geographic area as the buyer. This may be facilitated by analyzing zip code information, for example. Buyers may also be able to set a bidding profile for an item which will enable automated bidding to occur up to a pre-set limit. In addition, buyers may be able to set the bidding profile for an item to include automated computer notification when the user has made a winning bid, or has lost the bid, or both. Alternatively, information for customizing search results may be entered each time a user accesses the marketplace system 400.

As previously mentioned, a provider of the service marketplace system 400 may receive compensation for enabling a service provider to sell its services in a unique manner. Different fee arrangements may be employed.

For example, in a pay-per-transaction arrangement, the service provider pays the provider of the service marketplace system 400 when a sales transaction is completed. Accordingly, if a plumber offers a service call for a leaky faucet as a subject of an auction and accepts bids via the service marketplace system 400, where a buyer “wins” the service call via a bidding process facilitated by the service marketplace system 400, a percentage of the online payment received from the buyer for the service call may be allocated to the provider of the service marketplace system 400. Alternatively, a fixed and agreed-upon monetary amount may be provided to the provider of the service marketplace system 400 that is not dependent upon the sale price of the offered service that is the subject of a respective auction. For example, after facilitating online payment for a completed auction for an individual service listing, the service marketplace system 400 may electronically bill the business responsible for the individual listing a pre-arranged fee for each transaction completed on behalf of the business.

Another fee arrangement that may be employed in accordance with the present disclose is a pay-per-click arrangement, in one embodiment. In a pay-per-click arrangement, the service provider may pay a fee to the provider of the service marketplace system 400 that is based on the number of visitors that click (e.g., activates or selects using a mouse control) on a service listing to a web page for an auction of the service provider. The visitor does not have to buy anything related to the service listing. In fact, it does not matter what the visitor does after “clicking” on the link for the service listing, in one embodiment.

In this arrangement, a uniform resource locator (URL) or link clicked on by the visitor may contain several pieces of information, including an identification number for the service provider, an identification number for the provider of the service marketplace system, and a URL of a Web page containing the content of interest to the visitor. When a visitor clicks on the link, a “hit” is recorded on that particular URL which indicates which service provider received a visitor via the service marketplace system 400.

Another fee arrangement that may be employed in accordance with the present disclose is a pay-per-call arrangement, in one embodiment. In a pay-per-call arrangement, a service provider pays the provider of the service marketplace system 400 based on the number of visitors the system 400 refers to the service provider via a telephone number obtained from the service marketplace system 400. For example, in one embodiment, a service provider may be assigned a virtual phone number that is associated with the service provider and provided on one or more Web pages hosted by the service marketplace system 400. Therefore, whenever the phone number is called (and routed to an actual phone number of the service provider), it is known that the phone number originated from the service marketplace system 400. Accordingly, the service marketplace system 400 is credited for generating traffic to the service provider.

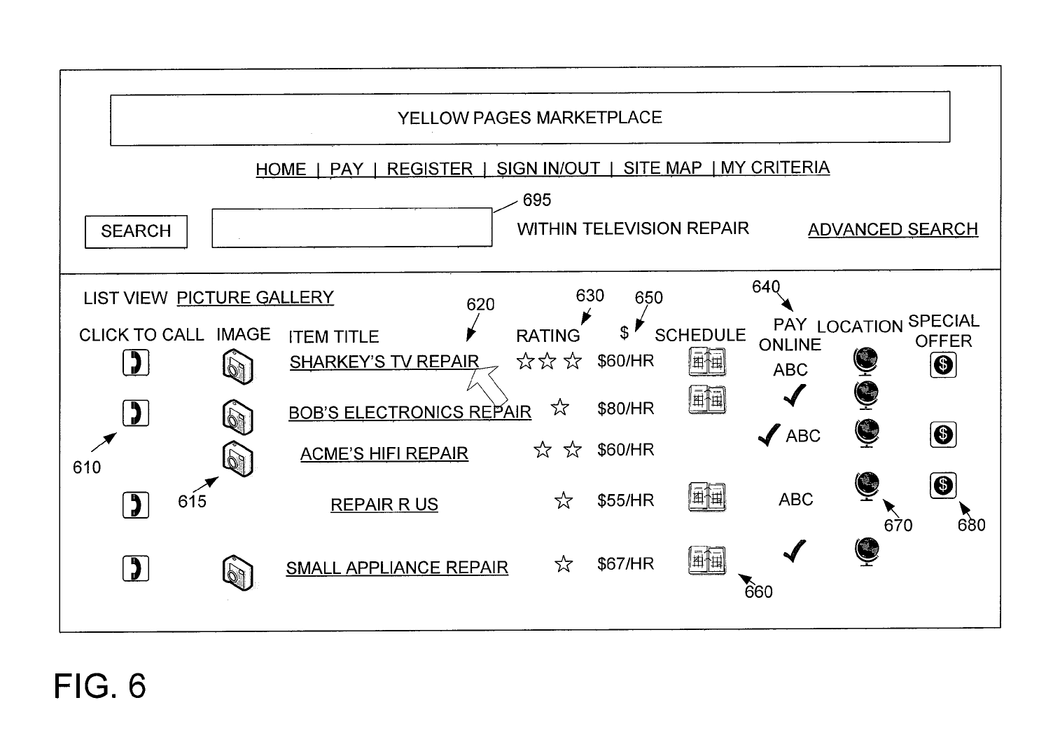

In another embodiment, a visitor may click a phone icon on a Web page hosted by the service marketplace system 400 (as later shown in FIG. 6) and be prompted to enter a phone number where the visitor may be reached. Soon thereafter, the service provider is connected with the phone number provided by the visitor and the service marketplace system 400 credits itself as generating traffic to the service provider.

Further, in another embodiment, if a visitor clicks on the phone icon, an Internet connection may be set up using voice over Internet protocol (VoIP) technology between the visitor and a representative of the service provider. Accordingly, the service marketplace system 400 may be credited with delivering the visitor to the service provider.

For each credited visitor of the above approaches, the service provider may pay an agreed-upon fee to the provider of the service marketplace system 400. In some embodiments, calls may be tracked and charged to the advertiser on a variable basis for how many calls are generated. Other approaches and advertising models may also be used in accordance with the present disclosure. For example, if a service provider does not perform very well in getting business via service listings for auctions, the service provider may arrange for an advertising to be shown adjacent to a listing of auction titles or categories. Therefore, a service provider may advertise without relying upon having service listings that are discovered by visitors.

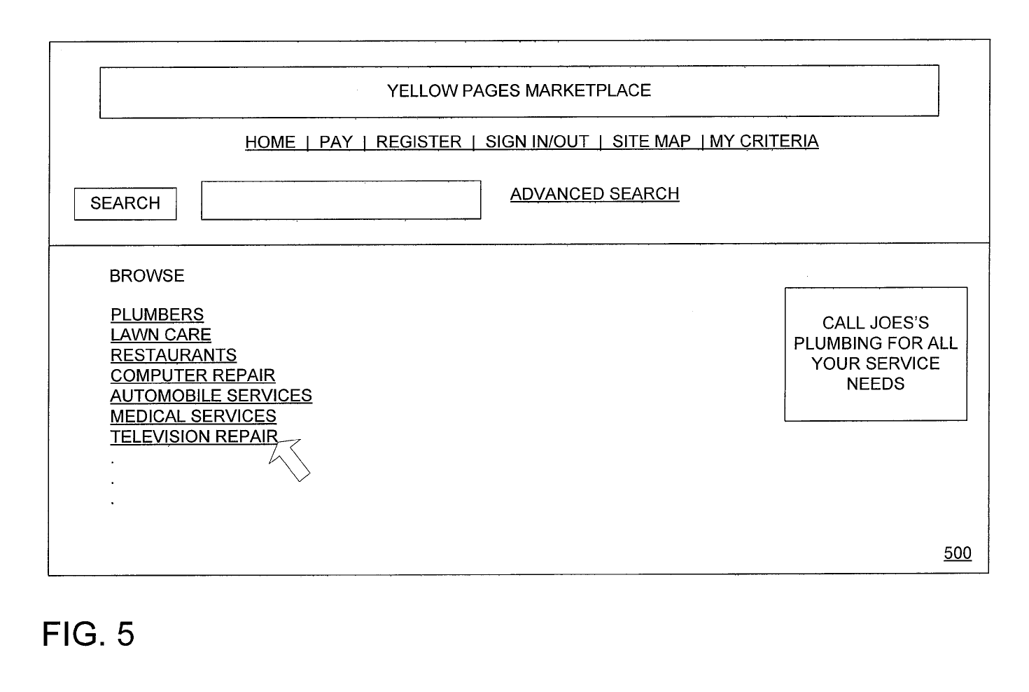

Referring now to FIG. 5, one embodiment of an interface 500 to a service marketplace system 400 is shown. In this embodiment, the interface 500 is illustrative of a Web page that may be displayed via a Web browser on a client device 110, 205. Via the interface 500, a visitor may browse through categories like Plumbers, Lawn Care, Restaurants, Computer Repair, Automobile Services, Medical Services, etc. When a visitor sees a category he or she likes, the visitor may click on the category to view items that are listed for auction within the selected category.

In one illustrative example, a buyer conducts a search of items within a nearby area. For example, in this case, a visitor goes to a web site, entitled “Yellow Pages Marketplace” and browses the category of television repair, as generally reflected in FIG. 5.

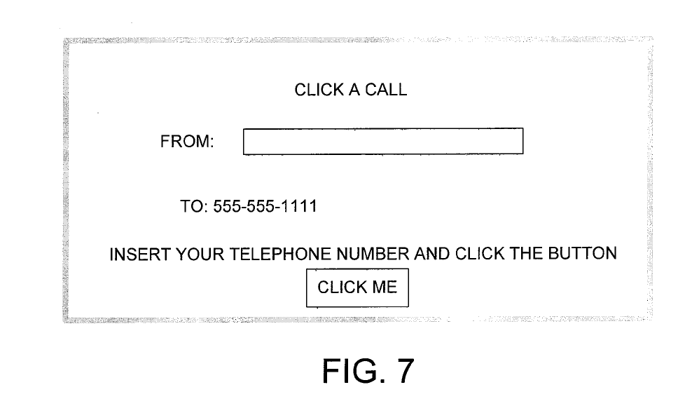

Multiple items are then returned in the search results, of which the first five items are shown, as displayed in the screen of FIG. 6. Next to some of the items is a phone icon or image 610. By clicking on the icon, a visitor may provide his or her telephone number, via an interface screen as shown in FIG. 7, so that the associated service provider can call the visitor.

Also shown in FIG. 6 is an auction title 620 that provides a brief description of the service being offered in that particular online auction. Also displayed are an icon for image information 615; an icon for payment information 640; consumer rating information 630; current pricing information 650; an icon indicating that scheduling information 660 is available, an icon indicating that location or geographic information 670 (e.g., mapping software) is available; and an icon indicating that a coupon or special offer 680 is provided, if a visitor decides to click on the auction title.

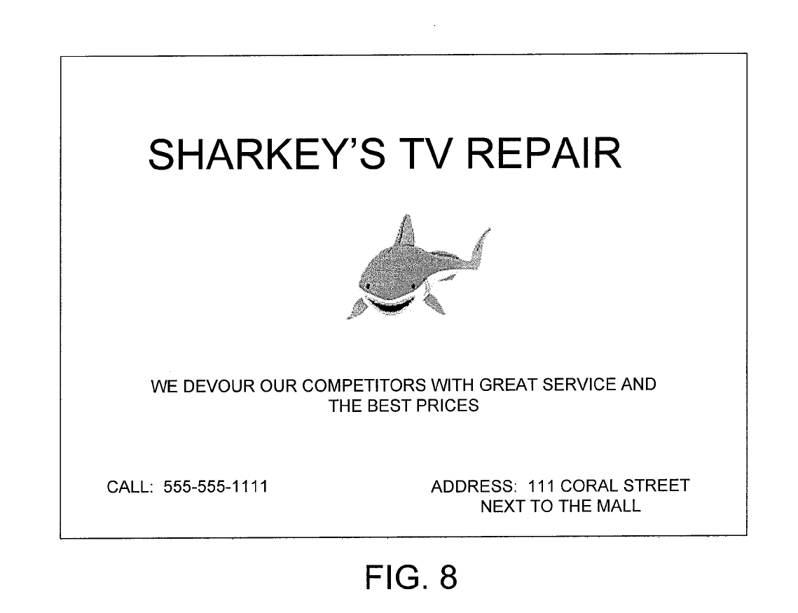

Therefore, in examining the list of auction titles and accompanying information, a visitor may click on an auction title 620 of the item to view the details of the item, including pictures, descriptions, payment options, scheduling information, etc. in a Web page. Further, in some embodiments, the visitor may click on an icon by itself from FIG. 6 to view a new window of information that is launched by the selection of the icon. For example, by selecting the image icon 615, a promotional image may be viewed for the offered service, such as an advertisement that is also featured in a yellow pages directory for the service provider. An illustrative advertisement is shown in FIG. 8 for the first listing in FIG. 6, Sharkey's TV Repair.

Note, in lieu of browsing for service listings, a visitor may search for a desired service using simple keywords in an search option 695 or using more advanced search criteria that helps narrow the results, such as keywords to exclude, item location, price range and accepted payment methods.

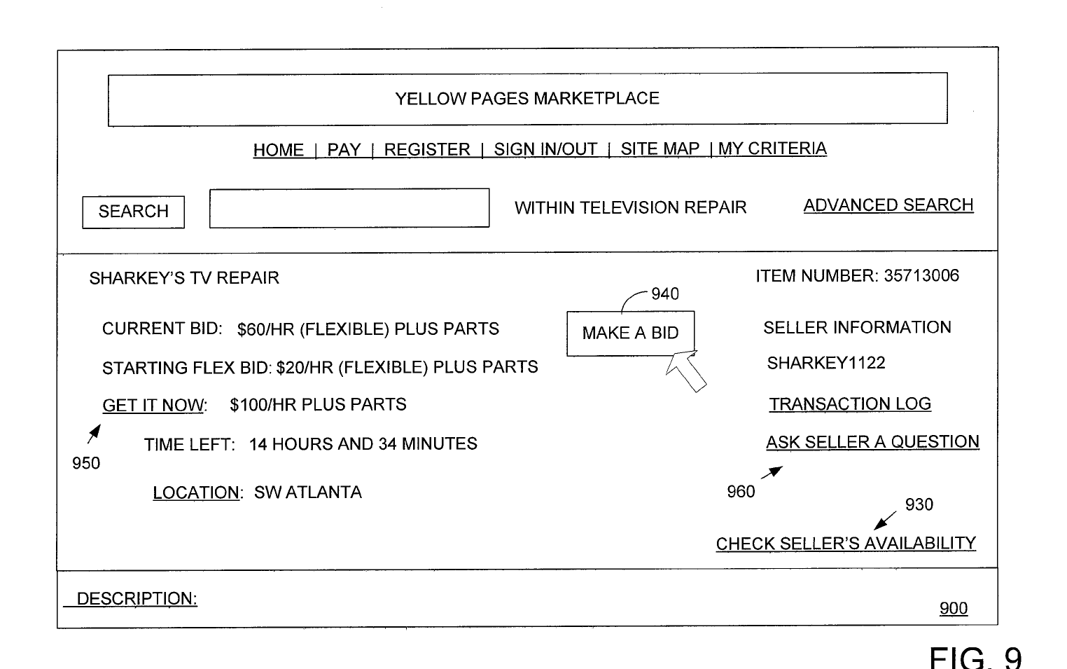

Referring again to FIG. 6, if a visitor clicks on an auction title 620 then, a screen of information shown in FIG. 9 may be provided, in one scenario. Here, information for Sharkey's TV Repair is shown, which is the first listing in FIG. 6.

The displayed information of FIG. 9 indicates that the current price for this service is $60/hour (plus parts) and the auction expires in 14 hours and 34 minutes. However, if a visitor desires to purchase the service immediately and not wait for the auction to expire, the visitor can purchase the item immediately at a premium “Get It Now” price of $100/hour (plus parts) and then schedule a service appointment using an online scheduling tool 140 via the Check Seller's Availability link 930.

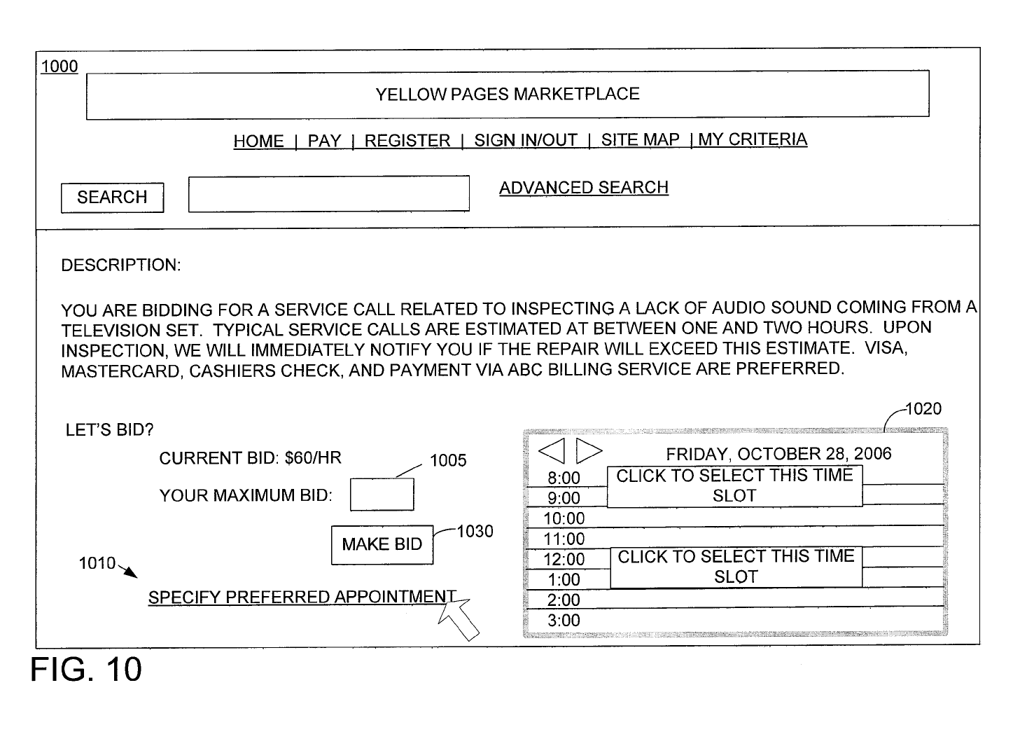

Otherwise, if the visitor decides to bid for the service by clicking the MAKE A BID button 940, additional description information is provided on a next screen, as shown in FIG. 10. The additional description information explains that the offered service that is up for bid pertains to a television service call related to inspecting a lack of audio sound coming from a television set. On this screen 1000, a bid amount may be entered in input box 1005 for the offered service. Also, current schedule information may be reviewed before the bid amount is entered, so that available dates can be checked for having the service performed. For example, in this particular illustration, a user may click the Specify Preferred Appointment link 1010 to open a window interface 1020 to a scheduling tool. If an available date is found, then the visitor may click on and select an available date to tentatively select and reserve that date as the date for the service call.

During the bidding process, a mechanism may be provided on a Web page of the service marketplace system for asking a seller a question, such as a link 960 provided on the same page 900 that provides the Make a Bid button 940.

Accordingly, when the bid amount is entered, the service date is also recorded. For the bid amount, the visitor may enter a maximum bid amount. During a bidding process, the service marketplace system may incrementally bid on the buyer's behalf until the bidding reaches the maximum amount entered.

Note, if a visitor places a bid on an item, he or she enters a contractual agreement to accept the offered service or work at the agreed upon price if the visitor wins the auction. Auctions may have minimum starting bids, reserve prices (e.g., a minimum amount the seller is willing to accept for the item, where if the bidding does not reach the reserve price, the seller does not have to complete a transaction for the item). There may also be service listings that give a visitor the option to “Get it Now” for a price that's typically higher than the auction's start price. If a visitor chooses to buy the item for the “Get it Now” price instead of bidding on it (e.g., by clicking the Get It Now link 950 in FIG. 9), the auction ends instantly. After the visitor clicks the Make a Bid button 1030, an additional confirmation screen may be displayed where the visitor can see the bid price and commit to it.

If a buyer wins an auction or chooses to buy an offered service at a Get It Now price, the buyer is notified that he or she was successful in purchasing the offered service. The notification may be provided to a user via a Web page of the service marketplace system 400 if the buyer is logged in as a user of the system 400 or an e-mail may be sent to the buyer as a notification with a URL for accessing the service marketplace system 400 so that payment may be rendered.

A buyer can pay for an item from the service marketplace system 400 using a variety of methods, including money order, cashier's check, cash, personal check and electronic payment services (e.g., PayPal, BidPay, WesternUnion.com, etc.). A seller may decide which payment methods they accept. Some payment methods may be built into an auction listing and may be completed as part of the service marketplace system. Once payment is completed, the service provider may provide a confirmation number that the service call has been established.

Before or after the transaction is completed and the service call has been performed, feedback regarding the transaction and service provided by the seller may be provided by buyer. If the seller has met all of their obligations (e.g., the provided service matched the offered service in the seller's description), then positive feedback may be left. Otherwise, negative or neutral feedback may be provided. Based upon cumulative feedback provided for a seller, the seller is accorded a customer rating. For example, in some embodiments, the seller is accorded a score based upon a percentage of the feedback for the seller that is positive.

Customer ratings and feedback is a way for a visitor to gauge trustworthiness of a seller. Likewise, a seller may also leave feedback for a buyer, and in this way, a buyer rating may be used by a seller to ascertain the trustworthiness of a buyer or visitor.

In some embodiments, a buyer may be afforded the opportunity to reschedule a date for a purchased service, if another available date is open. A rescheduling fee may be charged for performing this operation. Likewise, a buyer may be able to cancel a scheduled service call and be charged a cancellation fee. The cancellation fee and rescheduling fee may be automatically charged to a buyer's account that is maintained by the service marketplace system.

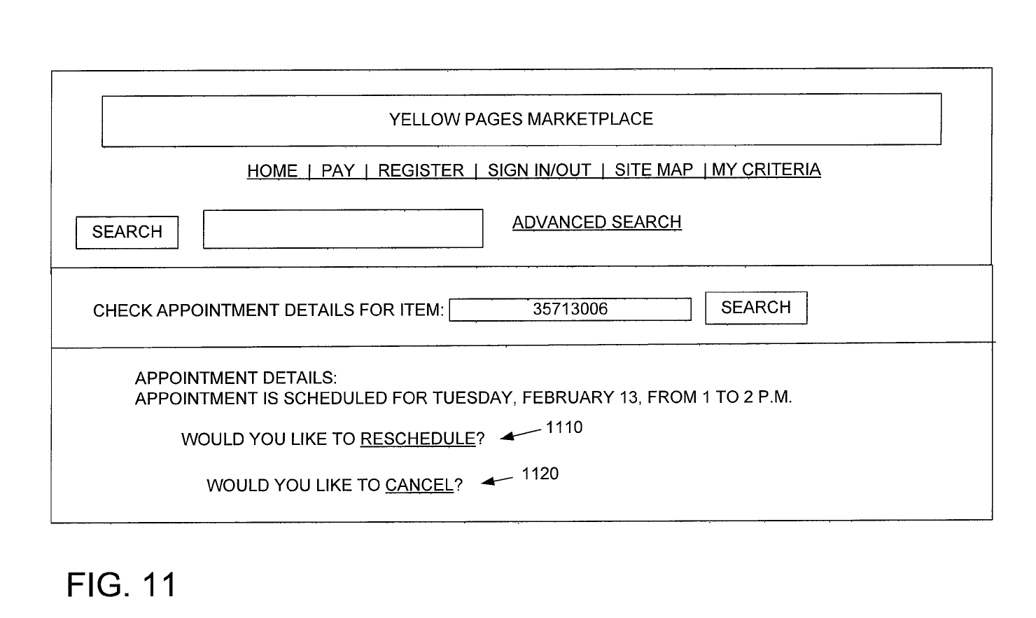

As an illustrative example, FIG. 11 displays an interface to the service marketplace system 400 that allows a user to view appointment information related to an auction item involving a user. In this illustration, the current appointment information is shown with options for launching mechanisms for rescheduling the appointment 1110 and/or canceling the appointment 1120.

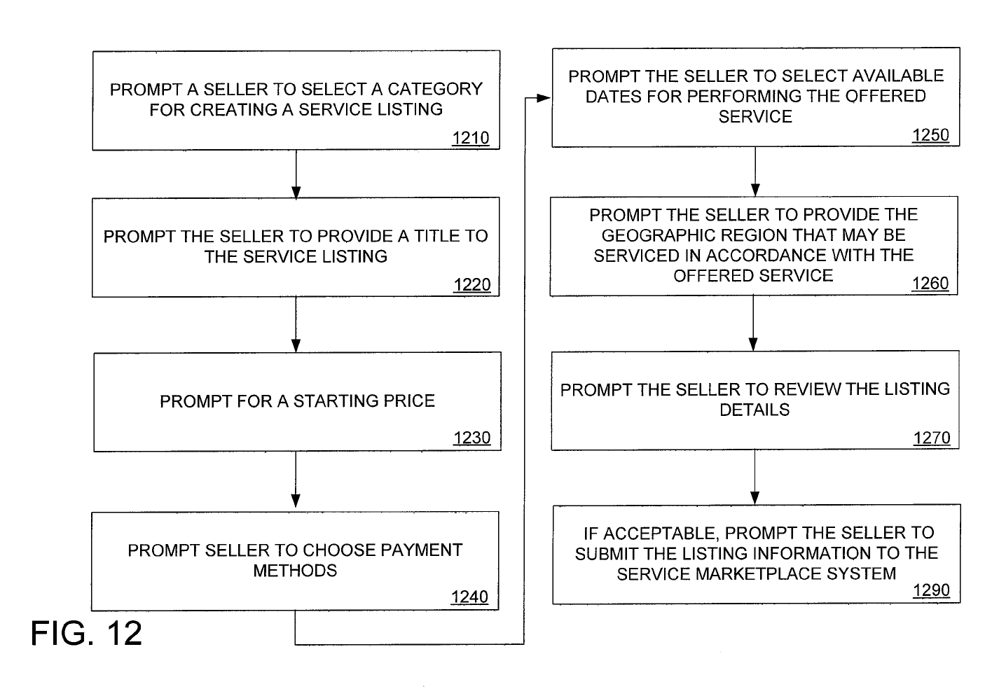

With regard to sellers and referring to the flow chart of FIG. 12, the service marketplace system 400 facilitates the creation of service listings. For example, an interface to the service marketplace system may prompt (1210) a seller to select a category for creating a service listing. For example, a television repair service may select consumer electronics as a service category. Then, the interface may prompt (1220) the seller to provide a title to the service listing, such as “Television Repair Service in Metropolitan Atlanta Area.” Therefore, a visitor in looking at the title can formalize an opinion on whether the service listing is potentially desirable.

Referring back to FIG. 12, another step in the process is that a starting price is prompted (1230) to be provided. The starting price may be specified as an hourly rate or a flat fee for a particular project, for example. Additionally, a reserve price may be specified along with other options that may be provided in the listing for a fee. For example, a Get it Now price could be offered or pictures, advertisements, coupons, mapping tools, etc. could also be offered by the service marketplace system 400 for various fees.

A seller may also be prompted (1240) to choose payment methods that may be accepted. Further, the seller may be prompted (1250) to select available dates via a scheduling tool 140 for performing the offered service. Further, the geographic region that may be serviced in accordance with the offered service may be prompted (1260) to be specified. In a final step, the seller is prompted (1270) to review the listing details and if acceptable, submit (1280) the listing information to the service marketplace system 400 so that it is posted and available to be viewed by visitors. In return for this service, the seller may be charged a listing fee. Further, the seller may also be charged a transactions fee if the offered service is purchased by a buyer based upon the listing. Accordingly, a provider of the service marketplace system 400 may be paid for facilitating a transaction for the service provider, which is advantageous over other advertising approaches of services, including hard copy telephone directories and online telephone directories where transactions that result from publications or advertisements are unable of being tracked.

Advantageously, publication of pricing information for services can be changed dynamically from day to day, hour to hour, minute to minute, etc. via the service marketplace system 400. Also, a seller can also set the duration for an auction to different times. It may be that the longer a bidder has to wait for an auction to complete, the less attractive it may be.

Advantageously, the service marketplace system is capable of adjusting to economic trends. For example, there may be some periods where service providers have lots of business and can charge high prices for their services. Also, there may be some periods where service providers do not have a lot of business and are willing to charge reduced prices for their services.

Likewise, consumers may have periods where they are willing to pay a lot for services and vice versa. Also, consumers may be willing to pay heightened prices for immediate scheduling of services instead of having to wait. Such trends or individualized needs are capable of being met by the features of embodiments of the service marketplace system 400.

To illustrate different scenarios of flexible bidding approaches that may be facilitated by the service marketplace system 400, the following examples are discussed and illustrated in the following figures.

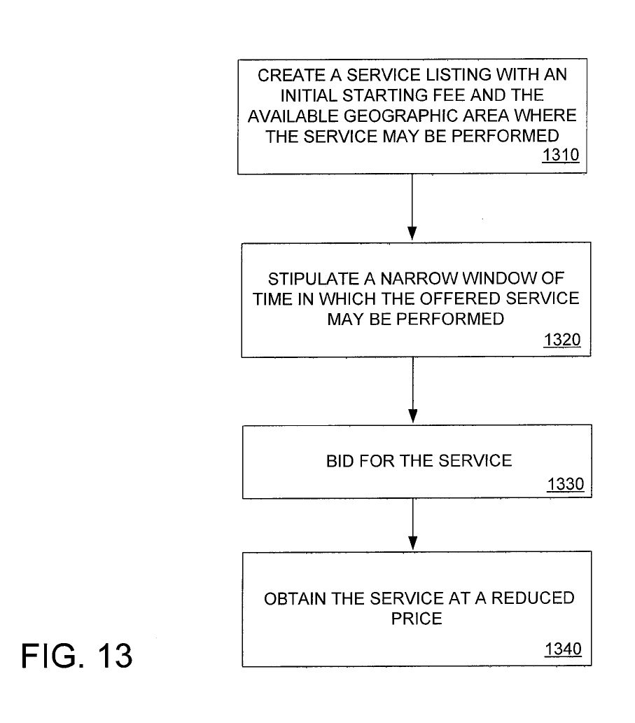

In a first scenario, as illustrated in the flowchart of FIG. 13, a seller may create (1310) a service listing with an initial starting fee for the service and the available geographic area where the service may be performed and other pertinent information. In specifying the service listing, the seller may stipulate (1320) a narrow window of time in which the offered service may be performed (e.g., 2 p.m. on Thursday, February 2^{nd}). Therefore, if a buyer has a flexible schedule to meet the seller's requirement, he or she may bid (1330) for the service and may obtain (1340) the service (upon winning the auction) at a reduced price than is usually obtained for such a service, since there may not be much demand or interest for the stipulated appointment time.

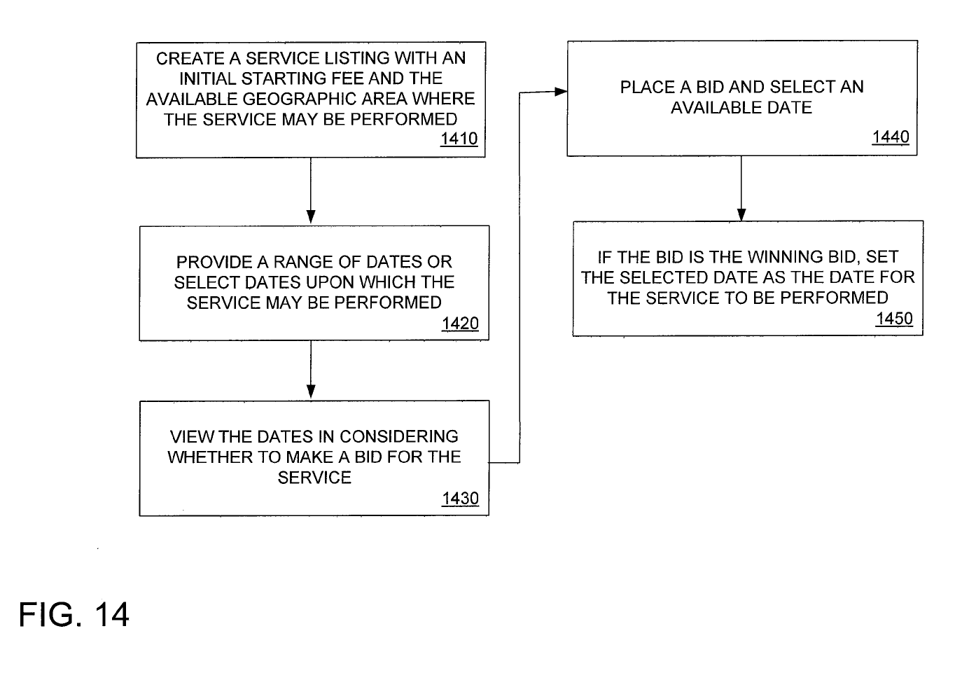

Next, in another scenario, as illustrated by the flow chart of FIG. 14, a seller may create (1410) a service listing with an initial starting fee for the service and geographic limitations on where the service may be performed. Further, in specifying the service listing, the seller may provide (1420) a range of dates or select dates upon which the service may be performed. For example, a scheduling tool 140 may be provided to the seller upon which a seller may view a calendar of dates and mark certain dates as available for the service to be performed and other dates that are reserved and are not available to be selected by a buyer. Therefore, a buyer may view (1430) the calendar of dates via the scheduling tool 140 in considering whether to make a bid for the service. If a buyer finds an acceptable date that is available, the buyer may then place a bid and select (1440) the available and acceptable date. The selected date is then associated with the bid placed by the buyer. If the bid is the winning bid, then the selected date is automatically set (1450) as the date for the service to be performed.

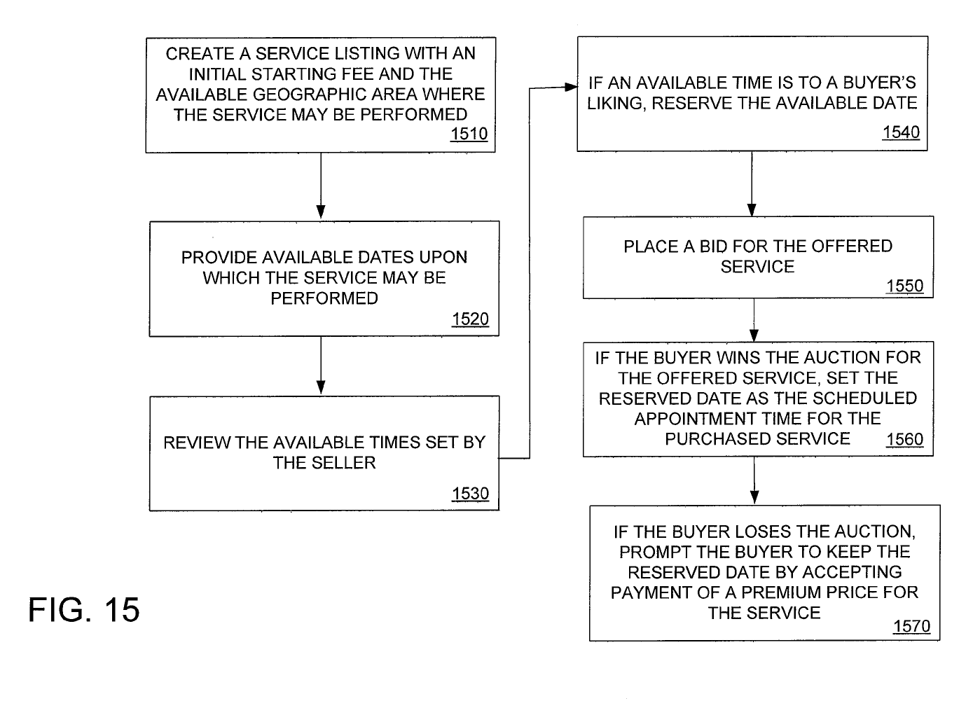

In an additional scenario, as illustrated by the flow chart of FIG. 15, the seller creates (1510) a listing with a starting price and geographic limitations on where the service may be performed. The seller may also provide (1520) available dates upon which the service may be performed.

In considering the listing, a buyer may then review (1530) the available times set by the seller. If an available date or time is to the buyer's liking, the buyer is able to lock or reserve (1540) the available date (e.g., for a fee). Then, the buyer may place (1550) a bid in an attempt to win the auction for the offered service. Accordingly, if the buyer wins the auction for the offered service, the selected date is set (1560) for the purchased service. If the buyer loses the auction, however, the buyer is offered (1570) an opportunity to keep the reserved date by paying a premium price for the service (e.g., the original Get It Now price selected by the seller when the listing was created). For example, although an auction may have been won by another buyer at a price of $70/hour, the buyer may accept to keep his or her reserved date for the offered service by accepting a premium price of $100/hour (the Get It Now price) for the service.

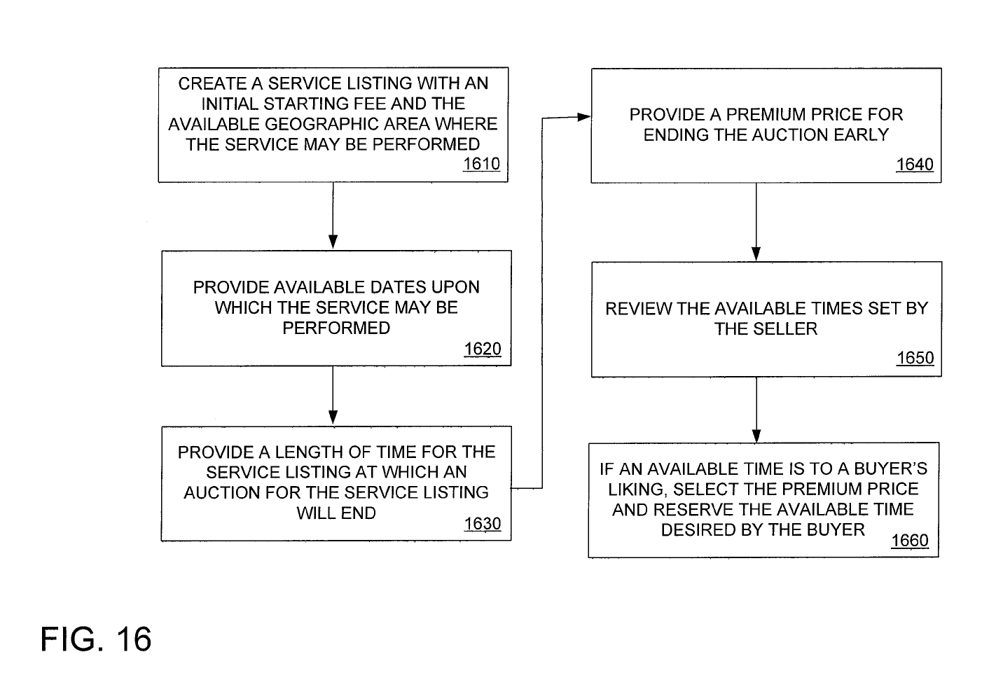

In another scenario, as illustrated by the flow chart of FIG. 16, a seller creates (1610) a service listing and provides pricing information and geographic limitations and available times (1620) for performing the service. Further, as previously discussed, a seller provides (1630) a length of time (e.g., 48 hours) for the service listing at which an auction for the service listing will end.

A seller may also specify (1640) a premium or Get It Now price for ending the auction early, where a buyer may immediately obtain the offered service at the premium price. A buyer may then review (1650) the available times and find one of his or her liking.

Since a date is available to his or her liking, the buyer chooses or selects (1660) to pay the premium Get It Now price to end the auction early and be assured of getting the desired time for the service to be performed. Accordingly, using a scheduling tool 140, the buyer schedules the desired and reserves the available date for the service. In some embodiments, online payment for the offered service may be necessary before the transaction can be completed and the desired date may be reserved.

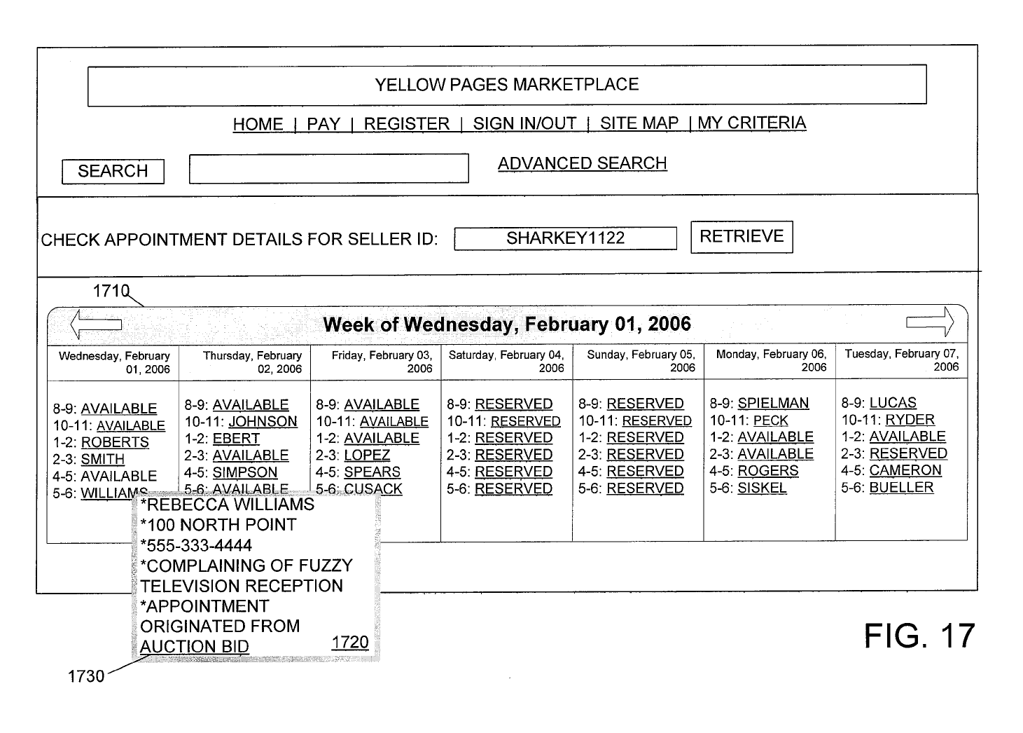

As previously mentioned, in some embodiments, a seller is able to monitor and set appointment information via a scheduling tool 140 provided by the service marketplace system 400. For example, FIG. 17 displays an interface to the service marketplace system 400 that allows a seller to view appointment information related to scheduled appointments for the seller. For example, by providing a unique seller ID (e.g., “Sharkey1122”), a calendar 1710 showing appointment information may be retrieved and displayed by a Web page of the marketplace system 400.

In the illustration shown, different time slots are shown for each calendar day, with some of the slots filled with the last name of a person who has scheduled an appointment, or with the designation “Available” for a slot that has not been filled but is available to be filled, or with the designation “Reserved” for a slot that is not available to be filled for a service appointment. Further, by clicking on an entry, additional information may be shown for that entry.

In the example shown, a window interface 1720 has been opened for “Williams” that shows the full name of the customer, address information, contact information, and the problem to be serviced. Further, comments may also be included such as the source of the appointment. For example, if the appointment was generated by an auction from the service marketplace system 400, a link 1730 may be provided to a Web page for the particular auction and the auction results.

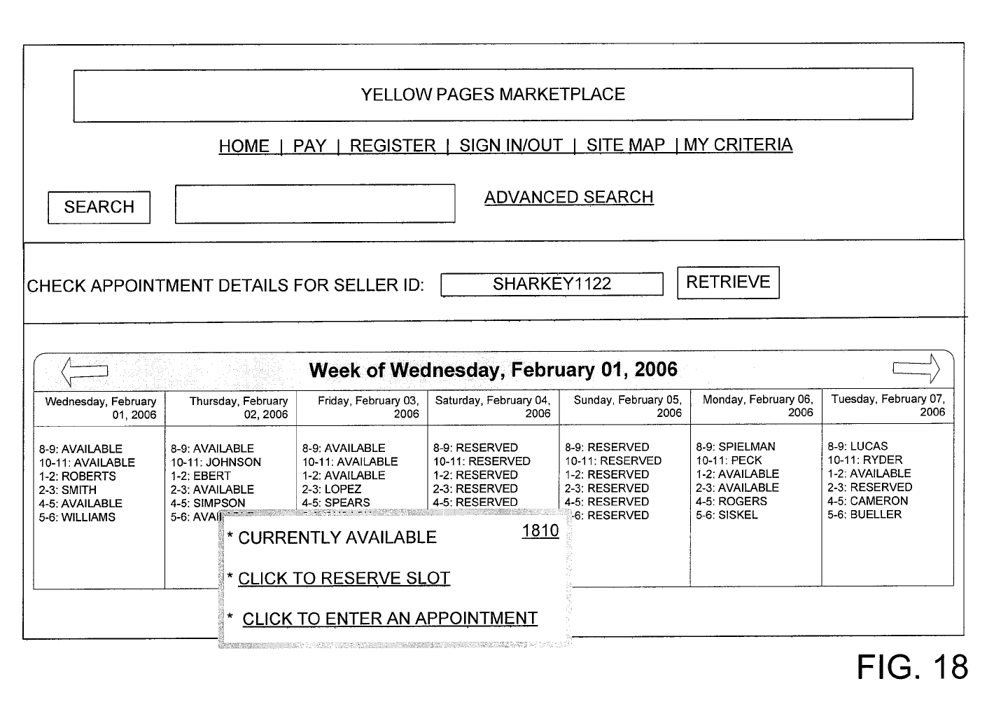

Accordingly, in FIG. 18, a window interface 1810 has been opened for an “Available” designation that allows a representative of the service provider to change the status of the designation, if desired. For example, if a person is unable to handle a service call at that time period, the designation may be changed to reserved so that an appointment is not able to be scheduled. Alternatively, a representative of the service provider may choose to enter an appointment into the system 400 bypassing the auction process. As previously mentioned, a service provider is able to directly access the scheduling tool 140, in some embodiments.

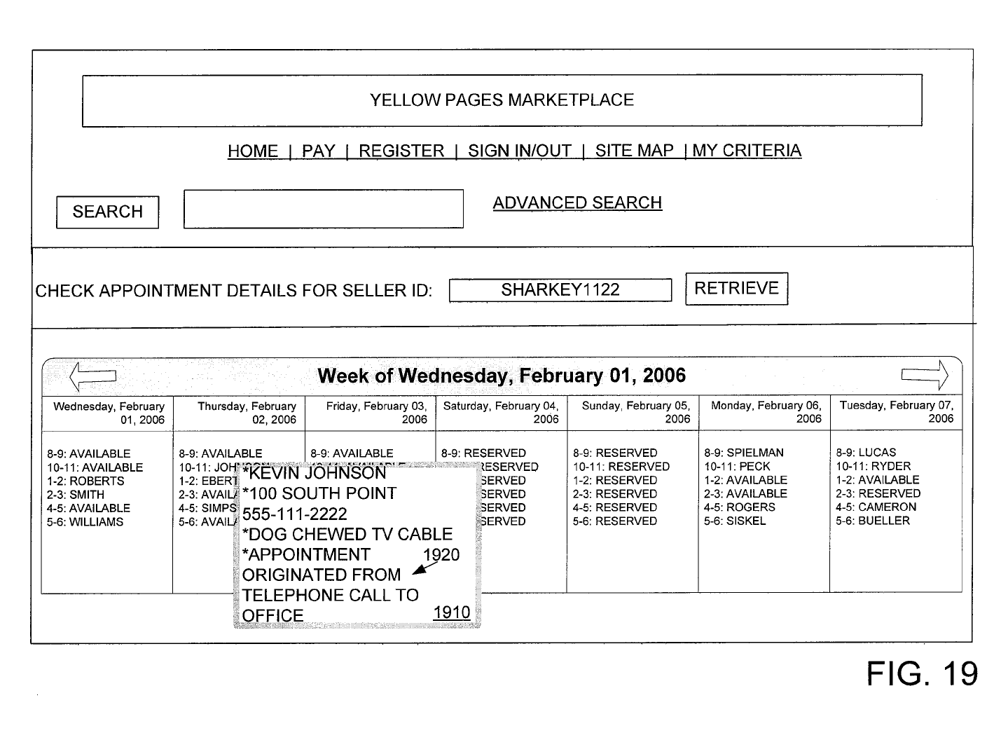

For example, if the representative schedules a service call over the phone, the representative could add this appointment to the online calendar by entering the information into one of the available slots. Therefore, as shown in FIG. 19, information displayed for an appointment made outside of the service marketplace system may indicate that the appointment originating from a telephone call as indicated by pointer 1920 for window interface 1910.

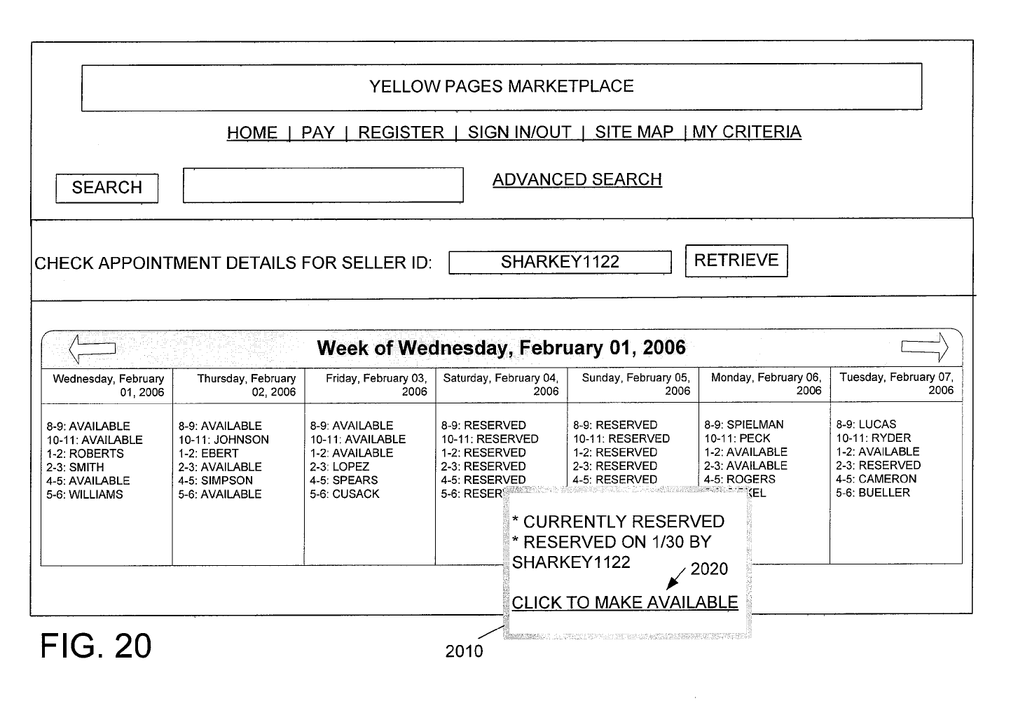

Likewise, as shown in FIG. 20, a window interface 2010 may be opened for an entry having a “Reserved” designation that may include comments (e.g., who requested the designation) and an option or link 2020 for changing the designation, such as to an available status.

With the service marketplace system 400, a variety of services may be offered. For example, a restaurant may create a service listing for the offering of a meal, including a particular menu item. In this way, service providers from all walks of life and occupations can benefit from embodiments of the dynamic directory auction system. For example, service providers that are new and just starting out can benefit from the service marketplace system by offering good service at fair prices where they may find it difficult to secure good advertising via other advertising models that rely on higher priced fees. Accordingly, the service marketplace system may generate different advertisers than that found in a standard telephone directory.

Further, due to the usefulness of the service marketplace system 400, it may be come an integral component of a service provider's business. For example, the service marketplace system 400 can act as a marketing department, advertising department, scheduling department, billing department, etc. for a particular business. Via the service marketplace system 400, businesses can differentiate themselves by their service propositions. Depending if they get good consumer reviews, businesses become more popular and attractive. Unlike a hard copy version of yellow page listing results where attractiveness of a listing may be based upon how much a plumber has paid for advertising, listings in a service marketplace may be based solely on consumer relevance, which is good for buyers and service providers that have a good consumer ratings and/or provide desired services.

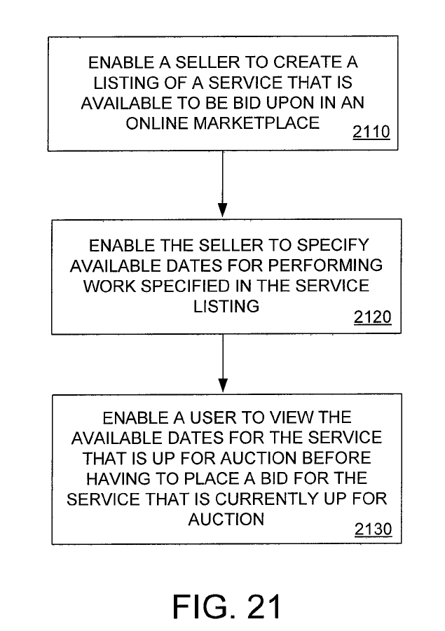

Referring now to the flow chart of FIG. 21, one embodiment of a process for selling services, in accordance with the present disclosure is described. The process includes the step of enabling (2110) a seller to create a listing of a service that is available to be bid upon in an online marketplace. The service entails work that is offered to be performed by the seller. The process further includes the step of enabling (2120) the seller to specify available dates for performing work specified in the service listing and enabling (2130) a user to view the available dates for the service that is up for auction before having to place a bid for the service that is currently up for auction. In some embodiments, additional and aforementioned features and steps may also be provided.

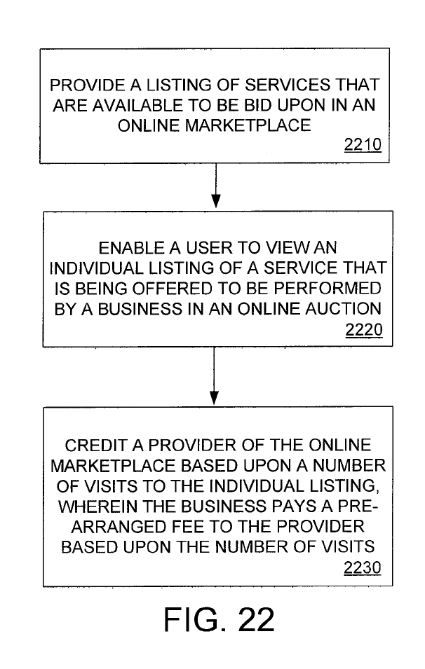

Next, FIG. 22 shows a flow chart describing another embodiment of a process for selling services. This process includes the step of providing (2210) a listing of services that are available to be bid upon in an online marketplace. The services includes work that is offered to be performed by a plurality of businesses. The process further includes the steps of enabling (2220) a user to view an individual listing of a service that is being offered to be performed by a business in an online auction and crediting (2230) a provider of the online marketplace based upon a number of visits to the individual listing, wherein the business pays a pre-arranged fee to the provider based upon the number of visits. In some embodiments, additional and aforementioned features and steps may also be included.

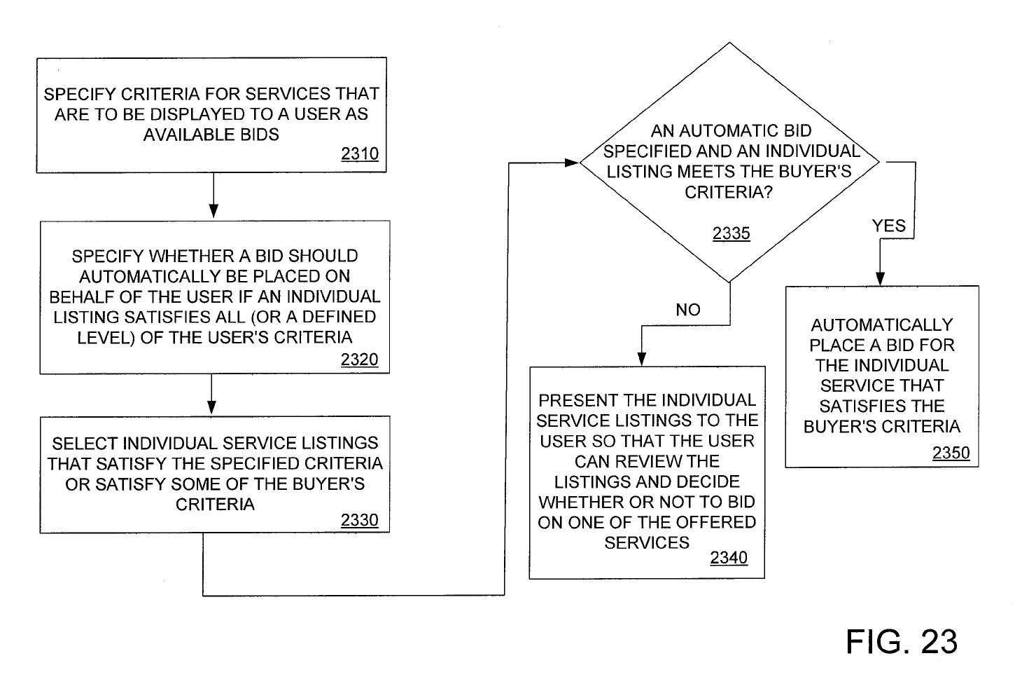

Referring now to FIG. 23, a flow chart describing an embodiment of a process for bidding on services is presented. This process includes the step of specifying (2310) criteria for services that are to be displayed to a user as available bids. The criteria, in one embodiment, are specified by the user who is interested in making a bid for a service. For example, the user may have a profile of criteria that the user would like potential services to satisfy. Such criteria may include preferred forms of payment, a maximum bid amount, a minimum rating, etc. Also, in some embodiments, a user may specify such criteria before a search is performed for available services that are currently up for auction. In addition to these criteria, the user may specify (2320) whether a bid should automatically be placed on behalf of the user if an individual listing satisfies all (or a defined level) of the user's criteria. The bid amount would be set in accordance with the user's maximum bid amount that is specified in the buyer's criteria. Accordingly, after criteria is specified, individual service listings are selected (2330) that satisfy the specified criteria or satisfy some of the buyer's criteria. In one embodiment, if (2335) the user did not specify that an automatic bid should be placed or if an individual listing does not meet all (or most) of the buyer's criteria, the individual service listings may be presented (2340) to the user so that the user can review the listings and decide whether or not to bid on one of the offered services. Accordingly, if (2335) the user did specify that an automatic bid should be placed and an individual listing does meet all of the buyer's criteria, a bid is automatically placed (2350) for the individual service that satisfies the buyer's criteria. In some embodiments, additional and aforementioned features and steps may also be included.

Any process descriptions or blocks in flow charts should be understood as representing modules, segments, or portions of code which include one or more executable instructions for implementing specific logical functions or steps in the process, and alternate implementations are included within the scope of some embodiments of the present disclosure in which functions may be executed out of order from that shown or discussed, including substantially concurrently or in reverse order, depending on the functionality involved, as would be understood by those reasonably skilled in the art of the present disclosure.

Components of embodiments of the present disclosure can be implemented in hardware, software, firmware, or a combination thereof. In one embodiment, various components are implemented in software or firmware that is stored in a memory and that is executed by a suitable instruction execution system. If implemented in hardware, as in an alternative embodiment, the components can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Software components, which comprises an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. Specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). The scope of the present disclosure includes embodying the functionality of some embodiments in logic embodied in hardware or software-configured mediums.

It should be emphasized that the above-described embodiments are merely possible examples of implementations, merely set forth for a clear understanding of the principles of the disclosure. Many variations and modifications may be made to the above-described embodiment(s) without departing substantially from the spirit and principles of the disclosure. For example, teachings of the present disclosure may be extended to an online marketplace for goods. Consider that in one embodiment, a marketplace may be provided where a buyer may view available dates for delivery of a good that is available for bidding before making a determination on whether or not to bid on the particular good. All such modifications and variations are intended to be included herein within the scope of this disclosure.

Therefore, having thus described the invention, at least the following is claimed:

1. A method for selling services, comprising:
enabling a seller to create a listing of a service that is available to be bid upon in an online marketplace, the service comprising work that is offered to be performed by the seller, wherein the listing is network-accessible by a client machine of a user;
enabling the seller to specify available dates for performing work specified in the service listing; and
enabling the user to view the available dates for the service that is up for auction before having to place a bid for the service that is currently up for auction.

2. The method of claim 2, further comprising:
tracking a number of visitors that access the service listing; and
crediting a provider of the online marketplace a monetary amount for each tracked visitor.

3. The method of claim 1, further comprising:
from the online marketplace, setting up a telephone call between a user and a service provider responsible for an individual listing;
tracking a number of visitors that have telephone calls set up by the online marketplace; and
crediting a provider of the online marketplace a monetary amount in accordance with the tracked number.

4. The method of claim 1, further comprising:
reserving an available date for performing work specified in the service listing on behalf of a buyer before the buyer wins an auction for the work.

5. The method of claim 4, further comprising:
terminating the auction early on behalf of a buyer agreeing to pay a premium price for the work that was designated by the seller when the listing was created, wherein the reserved date set by the buyer is automatically set as the scheduled date for performance of the work.

6. The method of claim 4, further comprising:
upon completion of the auction, enabling the buyer to set an appointment for the work to be performed at the reserved date for a premium price established by the seller although the buyer lost the auction for the work.

7. The method of claim 1, further comprising:
enabling online payment for the service upon completion of the auction and before performance of the work.

8. The method of claim 1, further comprising:
enabling the seller to view online dates for service appointments resulting from completed auctions of the seller.

9. A computer readable medium having a computer program for selling services, the program having instructions for performing the steps of:
enabling a seller to create a listing of a service that is available to be bid upon in an online marketplace, the service comprising work that is offered to be performed by the seller, wherein the listing is network-accessible by a client machine of a user;
enabling the seller to specify available dates for performing work specified in the service listing; and
enabling the user to view the available dates for the service that is up for auction before having to place a bid for the service that is currently up for auction.

10. The computer readable medium of claim 9, the program further comprising the steps of:
tracking a number of visitors that access the service listing; and
crediting a provider of the online marketplace a monetary amount for each tracked visitor.

11. The computer readable medium of claim 9, the program further comprising the steps of:
from the online marketplace, setting up a telephone call between a user and a service provider responsible for an individual listing;
tracking a number of visitors that have telephone calls set up by the online marketplace; and
crediting a provider of the online marketplace a monetary amount in accordance with the tracked numbers.

12. The computer readable medium of claim 9, the program further comprising the step of:
reserving an available date for performing work specified in the service listing on behalf of a buyer before the buyer wins an auction for the work.

13. The computer readable medium of claim 12, the program further comprising the step of:
terminating the auction early on behalf of a buyer agreeing to pay a premium price for the work that was designated by the seller when the listing was created, wherein the reserved date set by the buyer is automatically set as the scheduled date for performance of the work.

14. The computer readable medium of claim 12, the program further comprising the step of:
upon completion of the auction, enabling the buyer to set an appointment for the work to be performed at the reserved date for a premium price established by the seller although the buyer lost the auction for the work.

15. The computer readable medium of claim 9, the program further comprising the steps of:
enabling online payment for the service upon completion of the auction and before performance of the work; and
enabling the seller to view online dates for service appointments resulting from completed auctions of the seller.

16. A method for selling services, comprising:
providing a listing of services that are available to be bid upon in an online marketplace, the services comprising work that is offered to be performed by a plurality of businesses;
enabling a user to view an individual listing of a service that is being offered to be performed by a business in an online auction; and
crediting a provider of the online marketplace based upon a number of visits to the individual listing, wherein the business pays a pre-arranged fee to the provider based upon the number of visits.

17. The method of claim 16, further comprising:
automatically facilitating a telephone communication from a Web page describing the auction for the individual listing; and
crediting the provider of the online marketplace based upon a number of telephone communications facilitated for the individual listing, wherein the business pays a pre-arranged fee to the provider based upon the number of telephone communications.

18. The method of claim 17, further comprising:
facilitating online payment for a completed auction for the individual listing; and
after receipt of the online payment, electronically billing the business responsible for the individual listing a pre-arranged fee for each transaction completed on behalf of the business.

19. The method of claim 16, further comprising:
enabling an advertisement for the business to be displayed adjacent to a listing of services that are up for auction for other businesses.

20. The method of claim 19, further comprising:
enabling a telephone directory advertisement for the business to be displayed from a Web page of the auction for the individual listing.
